(19) United States
(12) Patent Application Publication
(10) Pub. No.: US 2005/0249033 A1
(43) Pub. Date: Nov. 10, 2005

(54) Disposable reciprocating bag mixing systems

(76) Inventor: Richard James Krause, Perkasie, PA (US)

Correspondence Address: WERNER & AXENFELD, LLP, P. O. BOX 1629, WEST CHESTER, PA, 19380, US

(21) Appl. No.: 10/838,576

(22) Filed: May 4, 2004

(51) Int. Cl. B01F 11/00

(52) U.S. Cl. 366/332

(57) ABSTRACT

A (disposable) single-use closed mixing system consisting of a mixing impeller(s) on a shaft, the shaft being sealed to the top of the bag. The flexible bag is used as the reciprocating membrane. Bag sizes 1 to 10,000 liters, can be gamma sterilized or non-sterile. The bags can be round or square in shape. All components including the impeller, shaft and accessories are CLASS VI material. The impeller or impellers used for large bags can be round, or square with holes, flutes, fins, tubing or a combination of these to meet specific mixing requirements. A detachable electric or air powered actuator provides the reciprocating action. The impeller shaft is sealed to the bag eliminating the need for rotary seals. Disposal of the mixing system is environmentally friendly.

### CROSS-REFERENCE TO RELATED APPLICATIONS

This invention is for a single-use (disposable) bag mixing system. The mixing shaft, impeller and bag are all disposable. There are no rotary seals. The mixer shaft is sealed to the bag with a port all components are made of polyethylene CLASS VI material. A stainless steel mixer sold by Chemap utilized a reciprocating mixer which required to be cleaned and steam sterilized between mixing. The mixer also required a rubber diaphragm attached to the stainless steel container. This mixer was not single-use disposable. The mixer was limited to small volumes.

### STATEMENT REGARDING FEDERALLY SPONSORED RESEARCH OR DEVELOPMENT

No federal assistance used

### BACKGROUND OF THE INVENTION

This mixing device relates to a single-use (disposable) mixing system which will target the Pharmaceutical and biotechnology industries but is not limited to these industries. Single-use sterile bag systems were introduced to the market in 1986. Initially bags were used to replace glass carboys and as disposable shipping containers for media and buffers used for cell cultivation. The advantageous of the single-use bags is the elimination of cross contamination which is a major problem with stainless steel and glass containers that must be cleaned and sterilized between usages. The need for mixing in a single-use bag became high over the last five years. Recirculation loops attached to the bag and rocking the bags have been the first attempts at mixing fluids in the disposable bags. The problem with theses methods is the limitations in volume that can me mixed with these method, and the speed of mixing. The reciprocating mixer provides an effective and low cost means for mixing in a closed bag system. Bag can be round or square to 10,000 liters. The variable speed of the reciprocating impellers, multiple mixing platforms (impellers) on the mixing shaft and the variable stroke allow the mixer to handle a broad range of mixing applications.

### BRIEF SUMMARY OF THE INVENTION

A single-use (disposable) mixing system for mixing liquids volumes up to 10,000 liter. The mixing system has no rotary seals. The impeller shaft is sealed to the top of the bag. The reciprocating motion uses the bag flexibility to allow mixing rates of 1 to 60 Hz. The mixing system is closed thus can be gamma sterilized to assure sterile mixing.

### BRIEF DESCRIPTION OF THE SEVERAL VIEWS OF THE DRAWING

FIG. 1 drawing of a typical single-use bag with mixing impeller sealed to the top of the bag

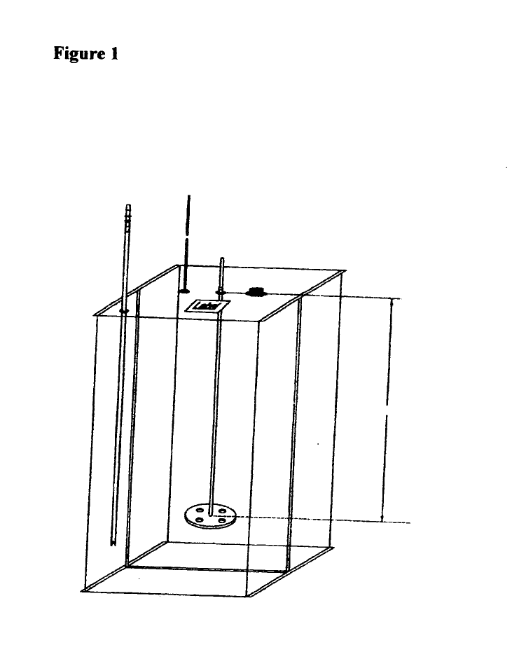

FIG. 2 drawing of bag with reciprocating actuator

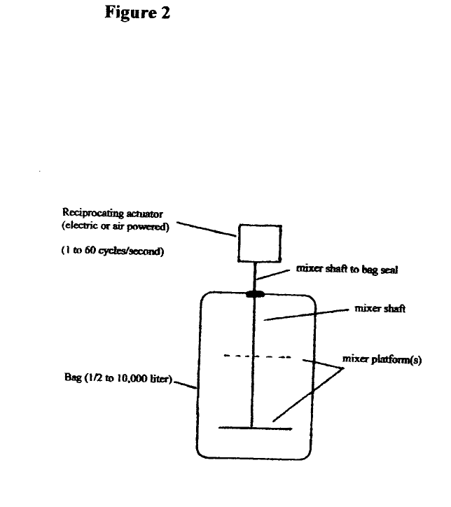

### DETAILED DESCRIPTION OF THE INVENTION Page

A single-use mixing bag utilizes the bag film as the mixing diaphragm, since the bag has no rotary seals. The bag is totally closed and can be gamma sterilized this reduces the chance of contamination in a biological process. The elimination of the rotary seal reduces the cost of the assembly. The impellers or impellers allow complete mixing of the fluids in bags up to 10,000 liters; the bags can be round or square in shape. All components must be CLASS VI material for bioprocess applications. The impeller is sized to match the size of the container; round or square with flutes, holes, tubing extensions and or combination of these to mixed the fluids. The reciprocating actuator is mounted on top of the container where the bags will be mixed. The mixing actuator is removed and the bag is loaded in the container. The bags in sizes over 30 liter is held in place when empty by the loops at four corners and the mixing actuators which connected to the bag with a quick discount coupling. The reciprocation speeds typical range to 250 rpm but higher speed is possible. The impeller stoke is 2 to 60 mm can be adjusted. In bags with one mixing impeller the impeller is near the bottom of the bags, when multiple impellers are used one impeller is placed mid way up the bag and the other near the top to assure complete mixing. After installing the bag and attaching the mixing actuator the bag is filled. If a sterile application a 0.1 or 0.2 micron filter is used on the fill line. If air is trapped in the fluids fill line an air pocket will develop in the top of the bag, this can be vented if it reduces the volume too much. After mixing is completed the bags is emptied and bag collapses around the mixing impeller(s). The bag with mixing shaft and impeller and all accessories are single-use.

1. Single-use (disposable) closed bag with reciprocating mixing impeller or multiple impellers for large bags, shaft sealed to the top of the bag.

2. No rotary seals, reciprocating mixer uses bag film as the reciprocating diaphragm

3. The reciprocating drive actuator is variable speed and stroke to allow mixing of different viscosity fluids
